(19) United States
(12) Patent Application Publication
(10) Pub. No.: US 2012/0287109 A1
(43) Pub. Date: Nov. 15, 2012

(54) DATA DRIVER AND DISPLAY MODULE USING THE SAME

(75) Inventors: Chia-Sheng CHANG, Hukou Township (TW); Jie-Jung Huang, Toufen Township (TW); Chih-Peng Hsia, Zhubei City (TW)

(73) Assignee: NOVATEK MICROELECTRONICS CORP., Hsinchu (TW)

(21) Appl. No.: 13/467,576

(22) Filed: May 9, 2012

(30) Foreign Application Priority Data
May 12, 2011 (TW) 100116747

(51) Int. Cl. G09G 5/00

(52) U.S. Cl. 345/212

(57) ABSTRACT

A data driver and a display module using the same are provided. The data driver includes a data line driving circuit and a power control circuit. The data line driving circuit drives data lines of the display module. The power control circuit controls an external power generating circuit connected to the data driver to generate a scan voltage for a scan driver of the display module.

This application claims the benefit of Taiwan application Serial No. 100116747, filed May 12, 2011, the subject matter of which is incorporated herein by reference.

### TECHNICAL FIELD

The disclosure relates in general to a power control circuit, and more particularly to a data driver integrating a power control circuit and a display module using the same.

### BACKGROUND

A power supply is a critical component in an electronic product to provide a stable and appropriate voltage. The quality of the power supply also affects the lifespan of the electronic product. To optimize the quality of the power supply, a power integrated circuit or a power management integrated circuit is for power control function. In the display field, the power integrated circuit provides circuits (e.g., a scan driver or a data driver) of a display module with an accurate and stable voltage reference.

In practice, inside a display, the display module is connected to external circuits. For example, circuits external to the display module include a printed circuit board for sending external signals to the display module for displaying. The external circuits also include a connection for connecting the display module with external circuit systems. Based on requirements of the display module, the connection may be such as a tape carrier package (TCP), a chip-on-flex or chip-one-film (COF) or a flexible printed circuit.

In general, to install the display module, the power integrated circuit is disposed at an external circuit of the display module, e.g., at a printed circuit board or at a connection, along with peripheral circuit components to generate power. However, such arrangement increases complexities of the external circuits as well as costs of the display module.

### SUMMARY OF THE DISCLOSURE

The disclosure is directed to a data driver and a display module using the same, which reduce complexities of external circuits as well as costs of the display module.

According to an example of the present disclosure, a data driver applicable to a display module is provided. The data driver includes a data line driving circuit and a power control circuit. The data line driving circuit drives data lines of the display module. The power control circuit controls an external power generating circuit connected to the data driver to generate a scan voltage for a scan driver of the display module.

According to another example of the present disclosure, a data driver applicable to a display module is provided. The data driver includes a data line driving circuit and a power control circuit. The data line driving circuit drives data lines of the display module. The power control circuit receives a detection signal and provides a control signal according to the control signal. A voltage level of the detection signal is lower than a scan voltage for a scan driver of the display module and varies with the scan voltage. The control signal controls generation of the scan voltage.

According to still another example of the present disclosure, a display module is provided. The display module includes a display panel, a scan driver and a data driver. The display panel includes scan lines, data lines intersecting the scan lines, and pixels located at intersections of the scan lines and the data lines. The scan driver receives a scan voltage and drives the scan lines. The data driver includes a data line driving circuit and a power control circuit. The data line driving circuit drives the data lines. The power control circuit controls an external power generating circuit connected to the data driver to generate the scan voltage.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 is a block diagram of a display module according to an embodiment of the present disclosure.

FIG. 2 is a schematic diagram of a power control circuit and a power power generating circuit in FIG. 1 as well as signals.

FIGS. 3A to 3C are a detailed example of the power generating circuit in FIG. 1.

### DETAILED DESCRIPTION OF THE DISCLOSURE

The present disclosure is directed to a data driver and a display module using the same. Integrating a power control circuit into the data driver controls an external power generating circuit connected to the display module for generating voltages for the display module, thereby reducing complexities of external circuits as well as costs of the display module.

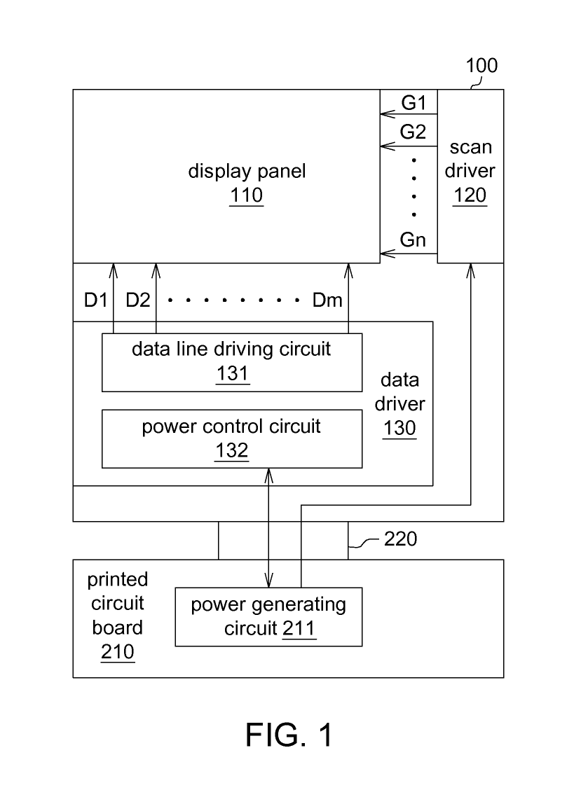

FIG. 1 shows a block diagram of a display module according to an embodiment of the present disclosure. The display module 100 includes a display panel 110, a scan driver 120 and a data driver 130. For example, the display module 100 is a liquid crystal display module and the display panel 110 includes a liquid crystal layer and two substrates. The display module 100 may be connected to a printed circuit board 210 via a connection such as a flexible circuit board 220 to form a display.

The display panel 110 includes scan lines G1 to Gn and data lines D1 to Dm. The data lines D1 to Dm intersect the scan lines G1 to Gn. The display panel 110 further includes pixels located at intersections of the scan lines G1 to Gn and the data lines D1 to Dm. The scan driver 120 drives the scan lines G1 to Gn. The data driver 130 includes a data line driving circuit 131 and a power control circuit 132. The data line driving circuit 131 drives the data lines D1 to Dm. The power control circuit 132 controls generation of a scan voltage for the scan driver 120. The scan voltage may be generated by a power generating circuit 211.

In an embodiment, for example, the power control circuit 132 is integrated with the data line driving circuit 131 to form a driver integrated circuit; and the power generating circuit 211 includes peripheral circuit components for generating power, such as capacitors, inductors, resistors and/or diodes. As shown in FIG. 1, the power control circuit 132 is integrated into the display module 100, and the power generating circuit 211 is disposed external to the display module 100, e.g., disposed at the printed circuit board 210 or at the flexible circuit board 220.

Compared to an approach that directly disposes a power integrated circuit or a power management integrated circuit external to the display module 100, according to an embodiment of the present disclosure, the power integrated circuit is divided into two parts—the power control circuit 132 and the power generating circuit 211. The power control circuit 132 is integrated with the internal data driver 130 of the display module 100. Thus, complexities of external circuits of the display module 100 and costs of the display module 100 may be lowered.

In general, the data driver 130 is in a power domain different from the external circuits such as the printed circuit board 210 or the flexible printed printed circuit board 220. A power domain is, for example, for defining a bearable range for a circuit or a component. In an embodiment, for example, the data driver 130 operates in a medium-voltage power domain or a low-voltage power domain, around 13V or below; and the printed circuit board 210 and the flexible printed circuit board 220 operate in a high-voltage power domain, around 20V. Compared to the high-voltage power domain, voltages in the low-voltage power domain are lower, so that components that operate in the low-voltage power domain bear lower voltages and thus have lower voltage endurance.

From perspectives of power domain and voltage endurance, the printed circuit board 210 and the flexible circuit board 220 are in the high-voltage power domain and their components have high voltage endurance. In contrast, the data driver 130 is in the medium-voltage power domain or low-voltage power domain and its components have low voltage endurance. Hence, the power control circuit 132 and the power generating circuit 211 are in different power domains. In other words, compared to components in the high-voltage power domain, circuit component of the power control circuit 132 in the medium-voltage power domain or in the low-voltage power domain have low voltage endurance, small layout area and low costs.

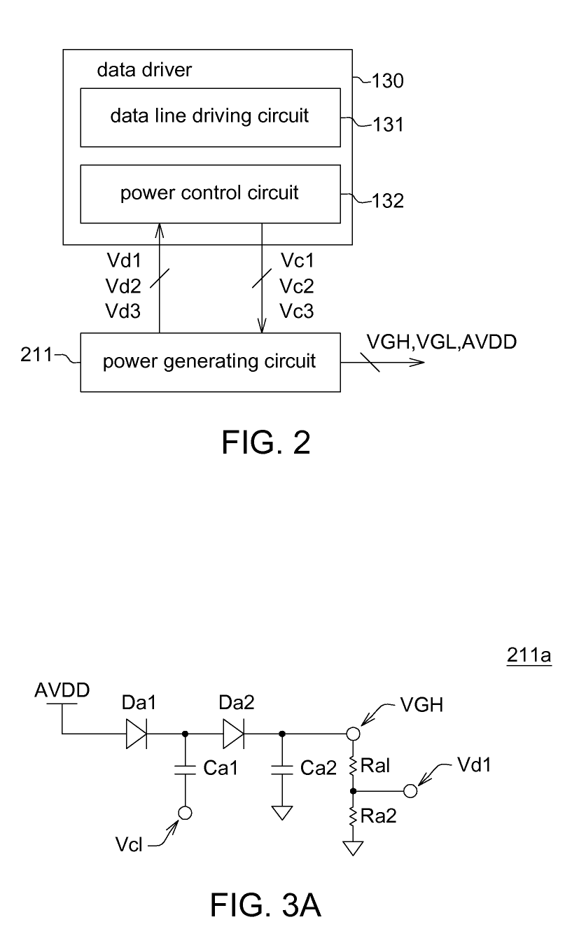

FIG. 2 shows a schematic diagram of the power control circuit 132 and the power generating circuit 211 in FIG. 1 as well as signals. As for the power control circuit 132 and the power generating circuit 211 in different power domains, signal exchange between the power control circuit 132 and the power generating circuit 211 may be appropriately designed. In an embodiment, voltage signals for controlling the power generating circuit 211 in the high-voltage power domain may be designed for the power control circuit 132 in the medium-voltage power domain or the low-voltage power domain.

In an embodiment, the power control circuit 132 controls generation of a scan voltage VHG, which is a positive voltage for the scan driver 120. In practice, the scan voltage VGH is defined in the high-voltage power domain, e.g., 15V. The scan application VGH is higher than the voltage endurance of components of the power control circuit 132 integrated in the data driver 130. Therefore, the power control circuit 132 may receive a detection signal Vd1 lower than the scan voltage VGH to provide a control voltage Vc1 for voltage control. The detection signal Vd1 varies with the scan voltage VGH, so the power control circuit 132 detects change in the scan voltage VGH and reflects the change on the control signal Vc1.

In another embodiment, the power control circuit 132 controls generation of a scan voltage VGL. The scan voltage VGL is a negative voltage for the scan driver 120. In practice, the scan voltage VGL is around −10V, for example. Similar to the positive scan voltage VGH, the power control circuit 132 receives a detection signal Vd2 having an amplitude lower than the scan voltage VGL to provide a control signal Vc2 for voltage control.

In yet another embodiment, the power control circuit 132 further controls generation of a data voltage AVDD. The data voltage AVDD is for the data driver 130. In practice, the data voltage AVDD is 10V, for example. Similar to the scan voltage VGH or VGL, the power control circuit 132 may also receive a detection signal Vd3 lower than the data voltage AVDD to provide a control signal Vc3 for voltage control.

In the embodiments above, generation of the detection voltages Vd1 to Vd3 may be depending on circuit designs. In an embodiment, the detection voltage Vd1 is a divided voltage from the scan voltage VGH, for example. In other words, for example, through serially connected resistors, a divided voltage from the power generating circuit 211 is fed back to the power control circuit 132 as a voltage control reference of the power control circuit 132. Generation of the detection voltages Vd2 and Vd3 may be realized according to similar approaches.

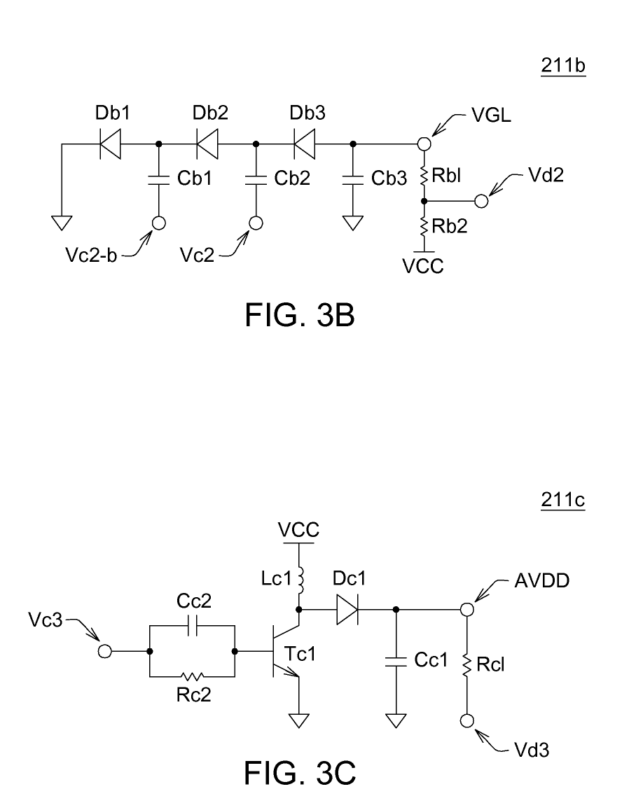

FIGS. 3A to 3C show a detailed schematic diagram of an example of the power generating circuit 211 in FIG. 1. In this example, the power generating circuit 211 includes three sub-circuits 211a to 211c, which respectively generate the positive-level scan voltage VGH, the negative-level scan voltage VGL and the data voltage AVDD.

As shown in FIG. 3A, a charge pump circuit is as an example of the sub-circuit 211a. The sub-circuit 211a includes circuit components, such as capacitors Ca1 to Ca2 and diodes Da1 to Da2. Through serial resistors Ra1 and Ra2, the sub-circuit 211a divides the scan voltage VGH as the detection voltage Vd1 and feeds the detection voltage Vd1 back to the power control circuit 132. By varying resistance ratio between the resistors Ra1 and Ra2, the detection voltage Vd1 is adapted to match the voltage endurance of the power control circuit 132. For example, the control signal Vc1 provided by the power control circuit 132 is a charge pump control signal. For example, the power control circuit 132 controls a level of the scan voltage VGH by changing signal levels or amplitudes. In this example, supposing the application voltage AVDD is 13V and the enabled level of the control signal Vc1 is 13V, the scan voltage VGH is then twice the above value, e.g., 26V.

As shown in FIG. 3B, the sub-circuit 211b, similar as the sub-circuit 211a, includes circuit components for example capacitors Cb1 to Cb3 and diodes Db1 to Db3. Biased by a power source VCC, the sub-circuit 211b divides the scan voltage VGL as the detection voltage Vd2 through serial resistors Rb1 and Rb2. Supposing an enabled level of the control signal Vc2 is 13V, its inverted signal Vc2-b has an inverted level, e.g., 0V. According to a conducting direction of the diodes, the scan voltage VGL has a negative level. Operational details of the sub-circuit 211b are similar to those of the sub-circuit 211a and shall be omitted for brevity.

As shown in FIG. 3C, a pulse width modulation (PWM) circuit is depicted as an example of the sub-circuit 211c. The sub-circuit 211c includes circuit components for example capacitors Cc1 to Cc2, a diode Dc1, an inductor Lc1, a transistor Tc1, and resistors Rc1 and Rc2. The sub-circuit 211c generates the detection voltage Vd3 through a feedback of the resistor Rc2. In this example, the control signal Vc3 provided by the power control circuit 132 is a PWM control signal having amplitude the same as the power source VCC, e.g., 3.3V. For example, the power control circuit 132 controls the data voltage AVDD by changing pulse width.

In the example shown in FIGS. 3A to 3C, the power source VCC (e.g., 3.3V) may be boosted to the high data voltage AVDD (e.g., 13V) through the PWM circuit. The data voltage AVDD is converted to the high scan voltage VGH (e.g., 20V) or VGL (e.g., −10V) through the charge pump circuit. Therefore, generation of high voltages may be controlled by a circuit having low voltage endurance. It is noted that, details of the example above are for describing the present disclosure and are not to be construed as limiting the present disclosure thereto.

With the description on the data driver and the display module using the same of the embodiments of the present disclosure, the power control circuit is integrated into the data driver for controlling generation of voltages for the display module, thereby reducing complexities of external circuits as well as costs of the display module.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the the disclosed embodiments as defined by the claims that follow.

What is claimed is:

1. A data driver applicable to a display module, comprising:
a data line driving circuit, for driving a plurality of data lines of the display module; and
a power control circuit, for controlling an external power generating circuit connected to the data driver to generate a scan voltage for a scan driver of the display module.

2. The data driver according to claim 1, wherein the power control circuit further controls the power generating circuit to generate a data voltage for the data driver.

3. The data driver according to claim 1, wherein the power control circuit receives a detection signal and provides a control signal according to the detection signal, a voltage level of the detection signal is lower than the scan voltage and varies with the scan voltage, and the control signal controls generation of the scan voltage.

4. The data driver according to claim 3, wherein the detection signal is a divided voltage from the scan voltage.

5. The data driver according to claim 3, wherein the control signal is a charge pump signal or a pulse width modulation (PWM) signal.

6. The data driver according to claim 1, wherein the power control circuit and the power generating circuit are in different power domains.

7. The data driver according to claim 1, wherein a voltage endurance of components of the power control circuit is lower than the scan voltage.

8. A data driver applicable to a display module, comprising:
a data line driving circuit, for driving a plurality of data lines of the display module; and
a power control circuit, for receiving a detection signal and providing a control signal according to the detection signal;
wherein a voltage level of the detection signal is lower than a scan voltage for a scan driver of the display module and varies with the scan voltage, and the control signal controls generation of the scan voltage.

9. The data driver according to claim 8, wherein the power control circuit further receives another detection signal and provides another control signal according to the another detection signal, a voltage level of the another detection signal is lower than a data voltage for the data driver and varies with the data voltage, and the another control signal controls generation of the data voltage.

10. The data driver according to claim 8, wherein the detection signal is a divided voltage from the scan voltage.

11. The data driver according to claim 8, wherein the control signal is a charge pump signal or a pulse width modulation (PWM) signal.

12. The data driver according to claim 8, wherein the control signal is provided to an external power generating circuit connected to the data driver so that the power generating circuit generates the scan voltage.

13. The data driver according to claim 12, wherein the power control circuit and the power generating circuit are in different power domains.

14. The data driver according to claim 8, wherein a voltage endurance of components of the power control circuit is lower than the scan voltage.

15. A display module, comprising:
a display panel, comprising:
a plurality of scan lines;
a plurality of data lines, intersecting the scan lines; and
a plurality of pixels, located at intersections of the scan lines and the data lines;
a scan driver, for receiving a scan voltage and driving the scan lines; and
a data driver, comprising:
a data line driving circuit, for driving the data lines; and
a power control circuit, for control an external power generating circuit connected to the data driver to generate the scan voltage.
